(19) United States
(12) Patent Application Publication
(10) Pub. No.: US 2022/0397957 A1
(43) Pub. Date: Dec. 15, 2022

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Ami KANZAKI, Kanagawa (JP)

(73) Assignee: FUJIFILM Business Innovation Corp., Tokyo (JP)

(21) Appl. No.: 17/509,085

(22) Filed: Oct. 25, 2021

(30) Foreign Application Priority Data
Jun. 11, 2021 (JP) 2021-097945

(51) Int. Cl. G06F 3/01; G06K 9/00; G06T 7/70

(52) U.S. Cl. CPC G06F 3/013; G06K 9/00604; G06T 7/70

(57) ABSTRACT

An information processing apparatus includes a processor configured to acquire a position of an eye front-mounted wearable terminal having a transmissive display placed in front of eyes of a user and a user's line-of-sight direction, and display, based on device information indicating an installation location and a status of a device at a position directly invisible to the user, the status of the device in the user's line-of-sight direction from the position of the wearable terminal, on the display.

### CROSS-REFERENCE TO RELATED APPLICATIONS

This application is based on and claims priority under 35 USC 119 from Japanese Patent Application No. 2021-097945 filed Jun. 11, 2021.

### BACKGROUND

### (i) Technical Field

The present invention relates to an information processing apparatus and a non-transitory computer readable medium storing an information processing program.

### (ii) Related Art

JP2020-129356A describes that a wearable terminal displays detailed information on the inside of an object in front of a user who wears a wearable terminal such as an eyeglasses-type. Further, SAP Japan official blog, “User Experience (UX) in the near future drawn by SAP Part 2: Three scenarios for utilizing wearable devices in business “(https:/www sapjp.com/blog/archives/10130) describes that according to an object seen by the user wearing smart glasses (eyeglasses-type wearable terminal), information on the work to be performed by the user is displayed on the smart glasses.

### SUMMARY

Incidentally, the user may want to grasp the status of a device at a position directly invisible to the user. In such a case, in a case where the user confirms the status of the device, the user needs to move to a position where the device is visible, or the user needs to perform an operation of accessing the computer that manages the status of the device.

Aspects of non-limiting embodiments of the present disclosure relate to an information processing apparatus and a non-transitory computer readable medium storing an information processing program, which enable the user to easily grasp the status of a device at a position invisible to the user, as compared with the case where the user moves to a position where the device is visible, or the user performs an operation of accessing the computer that manages the status of the device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire a position of an eye front-mounted wearable terminal having a transmissive display placed in front of eyes of a user and a user's line-of-sight direction; and display, based on device information indicating an installation location and a status of a device at a position directly invisible to the user, the status of the device in the user's line-of-sight direction from the position of the wearable terminal, on the display.

### BRIEF DESCRIPTION OF THE DRAWINGS

Exemplary embodiment(s) of the present invention will be described in detail based on the following figures, wherein:

FIG. 1 is a schematic configuration diagram of an information processing system according to the first exemplary embodiment;

FIG. 2 is a schematic configuration diagram of a wearable terminal;

FIG. 3 is a schematic configuration diagram of a server;

FIG. 4 is a diagram illustrating a first example in which a user wearing the wearable terminal looks at a direction of a device directly invisible to the user, in the first exemplary embodiment;

FIG. 5 is a diagram illustrating a first example of an image seen by the user through the wearable terminal;

FIG. 6 is a diagram illustrating a second example in which a user wearing the wearable terminal looks at a direction of a device directly invisible to the user, in the first exemplary embodiment;

FIG. 7 is a diagram illustrating a second example of an image seen by the user through the wearable terminal;

FIG. 8 is a diagram illustrating a third example of an image seen by the user through the wearable terminal;

FIG. 9 is a flowchart illustrating a processing flow of the server of the first exemplary embodiment;

FIG. 10 is a schematic configuration diagram of an information processing system according to a second exemplary embodiment;

FIG. 11 is a schematic configuration diagram of a mobile terminal;

FIG. 12 is a diagram illustrating an example in which a user points a camera of the mobile terminal toward a device directly invisible to the user, in a second exemplary embodiment; and

FIG. 13 is a diagram illustrating an example of a screen displayed on a display of the mobile terminal.

### DETAILED DESCRIPTION

### First Exemplary Embodiment

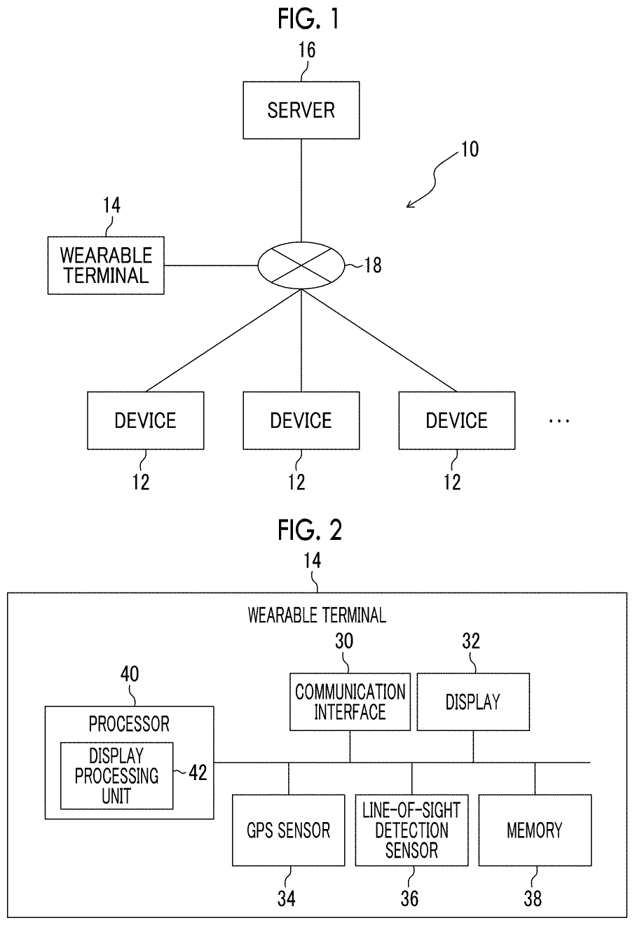

FIG. 1 is a schematic configuration diagram of an information processing system 10 according to a first exemplary embodiment. The information processing system 10 includes one or a plurality of devices 12, a wearable terminal 14 worn by a user, and a server 16 as an information processing apparatus. The device 12, the wearable terminal 14, and the server 16 are communicably connected to each other via a communication line 18 including, for example, an Internet line, a local area network (LAN), or a mobile phone communication line.

At least a part of the one or plurality of devices 12 are present in positions directly invisible to the user wearing the wearable terminal 14. For example, the device 12 is placed in a room different from a room in which the user is located. Further, for example, the device 12 is placed on a floor different from the floor on which the user is located. Further, for example, the device 12 is placed in a space separated from the user by a partition, a box, or the like.

The device 12 according to the present exemplary embodiment includes a printer that executes a printing process, and a processing machine that performs a pre-printing process or a post-printing process. The pre-printing process is, for example, a prepress process for creating a printing plate to be used for printing. The post-printing process is, for example, a folding process for folding printed paper or a bookbinding process. As described above, the plurality of devices 12 may be in charge of a part of a series of a plurality of processes. In other words, the processing product processed by one device 12 may be further processed by another device 12. Of course, the device 12 may perform a printing process and a process other than the pre-printing process and the post-printing process.

FIG. 2 is a schematic configuration diagram of the wearable terminal 14. The wearable terminal 14 is an apparatus that can be worn by the user. In particular, the wearable terminal 14 is an eye front-mounted wearable terminal 14 having a transmissive display placed in front of the user's eyes. Examples of such a wearable terminal include eyeglass-type terminals called smart glasses, and contact lens-type terminals that are worn in contact with the user's cornea.

Examples of a communication interface 30 include a network module and the like. The communication interface 30 exhibits a function of communicating with a server 16 via a communication line 18.

Examples of a display 32 include an organic EL. The display 32 is a transmissive display as described above. The transmissive display is a display in which the other side of the display can be seen through. In a case where an image is displayed on such a display, it appears to the user that the image is superimposed on the background on the other side of the display.

A GPS sensor 34 receives radio waves from a plurality of GPS satellites. The received information received by the GPS sensor 34 is transmitted from the communication interface 30 to the server 16. Alternatively, the GPS sensor 34 may calculate the position information indicating the position (latitude, longitude, altitude) of the wearable terminal 14 based on the received information. In that case, the calculated position information is transmitted to the server 16.

A line-of-sight detection sensor 36 is a sensor that detects the line-of-sight direction of the user wearing the wearable terminal 14. As a user's line-of-sight detection method, a known eye tracking technique can be used. For example, the line-of-sight detection sensor 36 may be a camera that captures a reflection point of light generated on the user's cornea. In this case, the user's line-of-sight direction is detected based on features such as the reflection point of light. Further, the line-of-sight detection sensor 36 may be an electrode for measuring the potential generated by the muscle for moving the eyeball. In this case, the user's line-of-sight direction is detected based on the potential measured by the electrode.

Further, the posture of the wearable terminal 14 may be regarded as the user's line-of-sight direction. More specifically, the direction that the display 32 faces (for example, the direction perpendicular to the display 32 and facing the side opposite to the user side) may be regarded as the user's line-of-sight direction. In this case, the line-of-sight detection sensor 36 may be, for example, an acceleration sensor that detects the acceleration of the wearable terminal 14 in the orthogonal three-axis directions. After calibrating, the posture of the wearable terminal 14 (particularly, the display 32) can be detected based on the detection signal of the acceleration sensor. The direction indicated by the posture detected by the acceleration sensor can be regarded as the user's line-of-sight direction.

The line-of-sight direction information indicating the user's line-of-sight direction detected by the line-of-sight detection sensor 36 is transmitted from the communication interface 30 to the server 16.

Examples of the memory 38 include a read only memory (ROM), a random access memory (RAM), a flexible memory element, and the like. The memory 38 stores a terminal ID that uniquely identifies the wearable terminal 14.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The processor 40 controls each part of the wearable terminal 14. Further, as illustrated in FIG. 2, the processor 40 functions as a display processing unit 42.

The display processing unit 42 performs a process of displaying various screens on the display 32, according to the display control signal received from the server 16 by the communication interface 30. Details of the screen displayed on the display 32 will be described later.

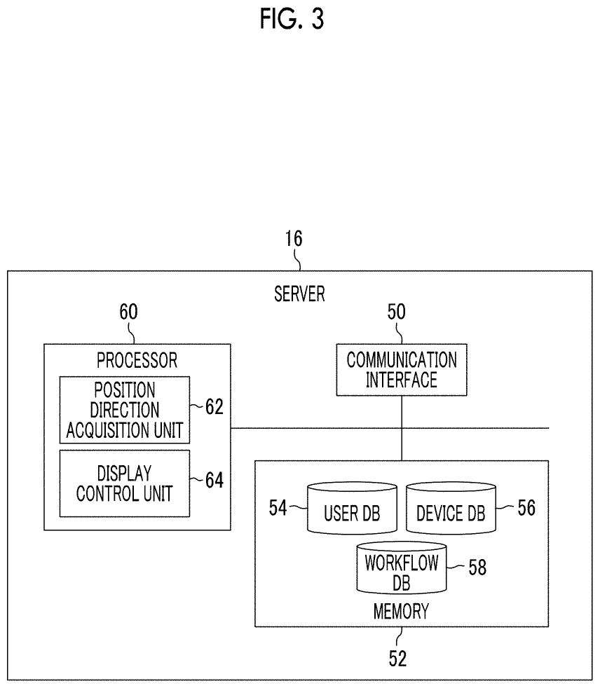

FIG. 3 is a schematic configuration diagram of the server 16. The server 16 is composed of, for example, a server computer, but may be any apparatus as long as the server 16 exhibits the functions described below. Further, the function of the server 16 described below may be achieved by a plurality of computers.

As will be described in detail later, in the present exemplary embodiment, the server 16 is used as a work management apparatus that manages the work performed by using the device 12. For example, the workflow of work using the device 12 (who performs the work of which process using which device 12), the work progress of the workflow, and the like are stored in the server 16. Further, the user may be able to browse the information on the workflow managed by the server 16.

Examples of the communication interface 50 include a network module and the like. The communication interface 50 exhibits a function of communicating with the device 12 and the wearable terminal 14 via the communication line 18.

Examples of the memory 52 include a hard disk drive (HDD), a solid state drive (SSD), an embedded multimedia card (eMMC), a ROM, a RAM, and the like. The memory 52 stores an information processing program for operating each part of the server 16. Further, as illustrated in FIG. 3, the memory 52 stores a user data base (DB) 54, a device DB 56 as device information, and a workflow DB 58.

The user DB 54 stores information on a user who has been registered as a user in the server 16 in advance. Specifically, the user DB 54 stores a user ID that uniquely identifies the user and a terminal ID that identifies the wearable terminal 14 used by the user in association with each other. Each piece of information stored in the user DB 54 is input to the server 16 by the user in a case where the user is registered.

The information on the device 12 is stored in the device DB 56. Specifically, a device ID that uniquely identifies the device 12, product information (information indicating the model number, function, capability, or the like) of the device 12, an image representing the device 12, installation location information indicating the location where the device 12 is installed, and device status information indicating the status of the device 12 are stored in association with each other. Information other than the device status information stored in the device DB 56 is input to the server 16 by the administrator of the server 16 or the like.

The device status information is intermittently transmitted from each device 12 to the server 16. The status of the device 12 indicated by the device status information is a concept that includes, for example, the state of the device 12 (for example, whether or not normal operation is possible), the execution status of the work performed using the device 12 (for example, whether or not the device 12 is in operation, what type of work is being performed, or the like), the progress of work performed using the device 12 (how far the work advanced, whether the work is advanced as planned, or the like).

The workflow DB 58 stores information for managing the work performed by using the device 12. For example, the workflow DB 58 stores information on the workflow of work using the device 12. Specifically, a case is considered where one or a plurality of users perform a workflow which includes a plurality of processes and in which work related to each process is performed by using each device 12. In this case, in the workflow DB 58, for each process included in the workflow, the user ID of the user who executes the work of the process, the device ID of the device 12 performing the work of the process, and the work content performed in the process are associated with each other. In addition, the workflow DB 58 also stores information indicating the execution order of each process. That is, in the workflow DB 58, information indicating who performs what type of work using which device 12 and in what order is stored. For example, a user A performs work A by using a first device 12 as a first process, and then a user B performs a work B by using a second device 12 as a second process. Alternatively, as the first process, the first device 12 and the second device 12 perform the work A and B, and as the second process, the user performs the work C by using a first product output by the first device 12 in the work A in the first process And a second product output by the second device 12 in the work B in the first process. The definition of the workflow stored in the workflow DB 58, as described above, may be registered by the user.

Further, each time the work related to each process is completed, the device 12 performing the work transmits a work completion notification to the server 16, so that the server 16 can store, in the workflow DB 58, which process of work has been completed in the workflow, that is, the work progress in the workflow.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

Further, as illustrated in FIG. 3, the processor 60 exhibits functions as a position direction acquisition unit and a display control unit 64, according to an information processing program stored in the memory 52.

The position direction acquisition unit 62 acquires the position of the wearable terminal 14. Specifically, the position direction acquisition unit 62 receives the received information received from the GPS satellite by the GPS sensor 34 of the wearable terminal 14, from the wearable terminal 14, and based on the received information, acquires the position (latitude, longitude, and altitude) of the wearable terminal 14. Alternatively, in a case where the GPS sensor 34 calculates the position of the wearable terminal 14, the position direction acquisition unit 62 acquires the position information indicating the position of the wearable terminal 14 from the wearable terminal 14. It can be said that the position of the wearable terminal 14 is the position of the user.

Further, the position direction acquisition unit 62 acquires the line-of-sight direction of the user wearing the wearable terminal 14. Specifically, the line-of-sight direction information detected by the line-of-sight detection sensor 36 of the wearable terminal 14 is received from the wearable terminal 14, and the user's line-of-sight direction is acquired based on the line-of-sight direction information.

Further, the position direction acquisition unit 62 acquires the user's field of view, based on the position of the wearable terminal 14 and the user's line-of-sight direction. The user's field of view is a region within a predetermined angle of view centered on the user's line-of-sight direction, with the position of the wearable terminal 14 as a reference (base point).

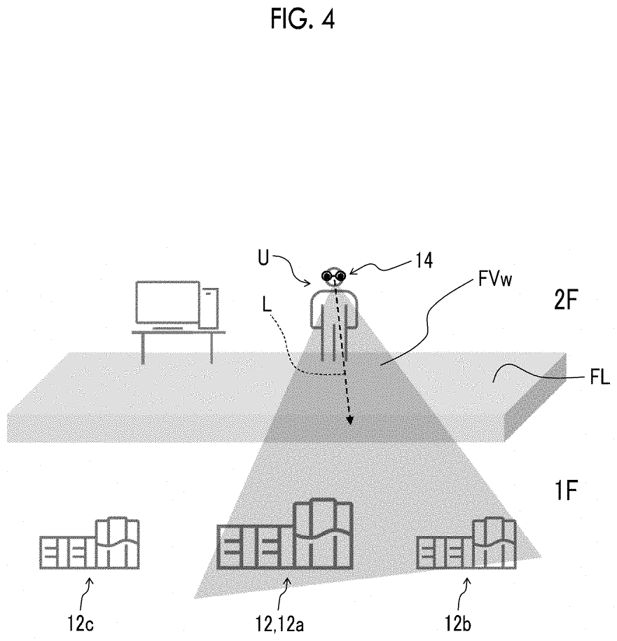

The display control unit 64 controls the display 32 of the wearable terminal 14 to display the status of the device 12 in the user's line of sight direction from the position of the wearable terminal 14, acquired by the position direction acquisition unit 62. In particular, the device 12 is a device 12 at a position directly invisible to the user. Hereinafter, the details of the processes of the position direction acquisition unit 62 and the display control unit 64 will be described with reference to FIGS. 4 to 8.

FIG. 4 is a diagram illustrating a first example in which a user U wearing the wearable terminal 14 looks in the direction of the device 12. In the example of FIG. 4, the user U is on the second floor of the building, and the plurality of devices 12 are installed on the first floor. The floor FL on the second floor is opaque, and the user U cannot directly see the plurality of devices 12.

In this environment, it is assumed that the user U wears the wearable terminal 14 and points the line-of-sight direction toward the device 12 (that is, the direction of the floor FL). At this time, from the wearable terminal 14, the terminal ID of the wearable terminal 14, the received information received by the GPS sensor 34 (or the position information indicating the position of the wearable terminal 14), and the line-of-sight direction information indicating the user's line-of-sight direction L are transmitted to the server 16.

The position direction acquisition unit 62 of the server 16 acquires the position of the wearable terminal 14 (in other words, the user U) indicated by the terminal ID and the line-of-sight direction L of the user U, based on the information from the wearable terminal 14. Further, the position direction acquisition unit 62 acquires the field of view FVw of the user U.

The display control unit 64 of the server 16 refers to the installation location information indicating the installation location of each device 12 stored in the device DB 56, and identifies a device 12 present in the line-of-sight direction L of the user U (more specifically, within the field of view FVw of the user U) from the position of the wearable terminal 14. In the example of FIG. 4, devices 12a and 12b are identified.

Then, the display control unit 64 refers to the device DB 56, acquires information on the identified devices 12 (here, devices 12a and 12b), and transmits a display control signal for displaying the information on the display 32 of the wearable terminal 14, to the wearable terminal 14 indicated by the received terminal ID. The information on the device 12 includes, for example, product information of the device 12, an image representing the device 12, device status information of the device 12, and the like. Thus, the display control unit 64 causes the display 32 to display information on the identified device 12.

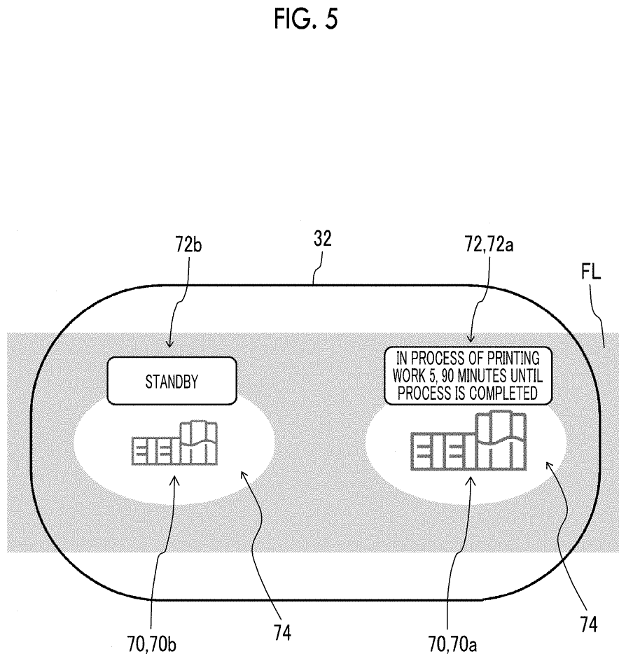

FIG. 5 is a diagram illustrating a first example of information displayed on the display 32. The display processing unit 42 of the wearable terminal 14 causes the display 32 to display information on the device 12, based on the display control signal received from the server 16. For example, the image 70 of the device 12, the device status information 72 of the device 12, and the like are displayed on the display 32. In the example of FIG. 5, the image 70a of the device 12a, the device status information 72a of the device 12a, the image 70b of the device 12b, and the device status information 72b of the device 12b are displayed on the display 32. As described above, since the display 32 is a transmissive display, these pieces of information are superimposed on the background (floor FL in the example of FIG. 5) that can be seen through the display 32, viewed from the user U.

In order to make the user feel as if the user is seeing the information on each device 12 through the floor FL, for example, the information on the device 12 may be displayed at a position corresponding to the installation location of the device 12, viewed from the user U. For example, in the example of FIG. 4, viewed from the user U, the device 12a appears to be on the right side of the device 12b. Therefore, for example, the display control unit 64 may display the information on the device 12a on the right side of the information on the device 12b. Further, the display control unit 64 may display an image 74 without a background of a single color (for example, white) around the image 70.

In the example of FIG. 5, as the device status information 72, the execution status of the work performed by the device 12 is displayed. For example, the device status information 72a indicates that the device 12a is “in the process of printing work 5”, and the device status information 72b indicates that the device 12b is “standby”.

Further, as the device status information 72, the progress of the work performed using the device 12 may be displayed. For example, according to the device status information 72a, “90 minutes until the process is completed” is indicated as the progress of the work performed using the device 12a.

The information indicated by the device status information 72 is not limited to the above. For example, product information (model number, function, capability, or the like) of the device 12 may be displayed.

In this way, since the status of the device 12 directly invisible to the user U is displayed on the display 32, as compared with the case where the user U moves to a position where the device 12 is visible, or the case where the user U performs the operation of accessing a computer that manages the status of the device 12, the user U can easily grasp the status of the device 12.

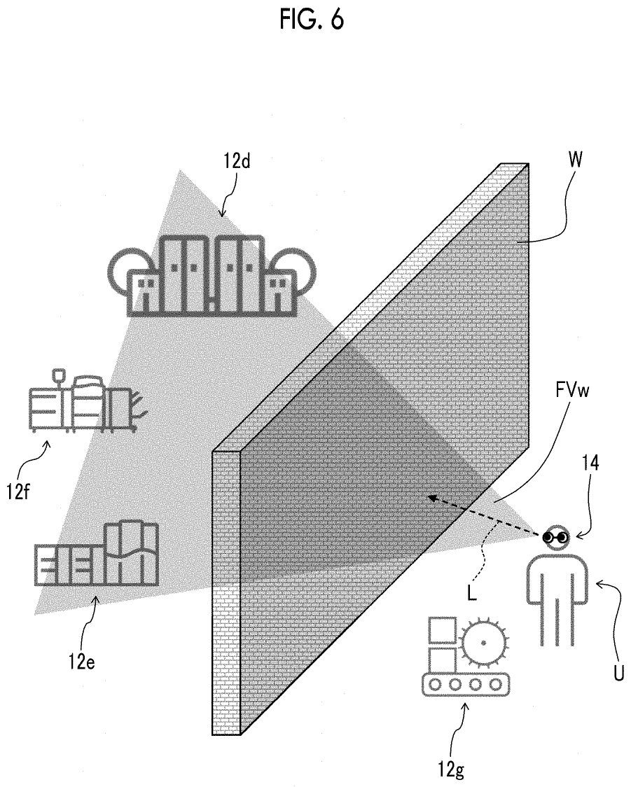

FIG. 6 is a diagram illustrating a second example in which a user U wearing the wearable terminal 14 looks in the direction of the device 12. In the example of FIG. 6, the user U is in a room different from the room in which the devices 12d to 12f are installed. A device of 12g is installed in the room where the user is. The wall W that separates the room where the user is and the room where the devices 12d to 12f are installed is opaque, so that the user U cannot directly see the devices 12d to 12f.

In the example of FIG. 6, it is assumed that a work performed by using the device 12d, a work performed by using the device 12e, and a work performed by the user U using the device 12g are the works included in one workflow X. It is assumed that the work performed by using the device 12f is a work not included in the workflow X. An example of the workflow X includes, for example, a process A, a process B performed after the process A, and a process C performed after the process B, and a user other than the user U performs the work of the process A by using the device 12d, a user other than the user U performs the work of the process B by using the device 12e, and a user other than the user U performs the work of the process C by using the device 12g. Alternatively, a user other than the user U performs the work of the process A by using the device 12d, the user U performs the work of the process B by using the device 12g, and a user other than the user U performs the work of the process C by using the device 12e. As described above, the work performed by the user U may be a work of pre-process or a post-process of the work using the device 12d or 12e. Information on such workflow X is stored in the workflow DB 58 as described above. Here, it can be said that the devices (device 12d and device 12e in the above example) that perform the work belonging to the same workflow (workflow X in the above example) as the work performed by the user are devices related to the user U. That is, it can be said that the information on the workflow X including the work performed by the user U is the related information indicating the relationship between the user U and the device 12 related to the user U.

Here, it is assumed that the workflow X is a workflow for performing a case binding process. Specifically, it is assumed that in the workflow X, a user other than the user U performs a cover printing process as a first product by using the device 12d as the process A, a user other than the user U performs a book body printing process as a second product by using the device 12e as the process B, and the user U performs the case binding process using the cover and the book body by using the device 12g as the process C.

In the example of FIG. 6, it is assumed that the user U wears the wearable terminal 14 and points the line-of-sight direction toward the device 12 (that is, the direction of the wall W). At this time, from the wearable terminal 14, the terminal ID of the wearable terminal 14, the received information received by the GPS sensor 34 (or the position information indicating the position of the wearable terminal 14), and the line-of-sight direction information indicating the user's line-of-sight direction L are transmitted to the server 16. The position direction acquisition unit 62 of the server 16 acquires the position of the wearable terminal 14 (in other words, the user U), the line-of-sight direction L of the user U, and the field of view FVw of the user U.

The display control unit 64 of the server 16 refers to the installation location information indicating the installation location of each device 12 stored in the device DB 56, and identifies a device 12 present in the line-of-sight direction L of the user U (more specifically, within the field of view FVw of the user U).

In the example of FIG. 6, there are three devices 12 in the user's line-of-sight direction L (within the field of view FVw): the device 12d, the device 12e, and the device 12f. Here, the display control unit 64 of the server 16 may display, on the display 32, the status of the device 12 related to the U, among the plurality of devices 12 present in the line-of-sight direction L of the user U, based on the related information indicating the relationship between the user U and the device 12 related to the user U. In the present example, the information on the workflow X stored in the workflow DB 58 is used as the related information.

The display control unit 64 refers to the user DB 54, and identifies the user ID of the user U who wears the wearable terminal 14, based on the terminal ID acquired from the wearable terminal 14. Next, the display control unit 64 refers to the workflow DB 58, and identifies the workflow X including the work performed by the user U. Then, the display control unit 64 identifies the device 12 that performs the work included in the workflow X, among the devices 12 present in the user's line-of-sight direction L, based on the information on the workflow X. Here, the devices 12d and 12e are identified. Then, the display control unit 64 transmits, to the wearable terminal 14, a display control signal for displaying the information regarding the identified devices 12d and 12e on the display of the wearable terminal 14. Thus, the display 32 displays the status of only the device 12 related to the user U, among the plurality of devices 12 present in the line-of-sight direction L of the user U.

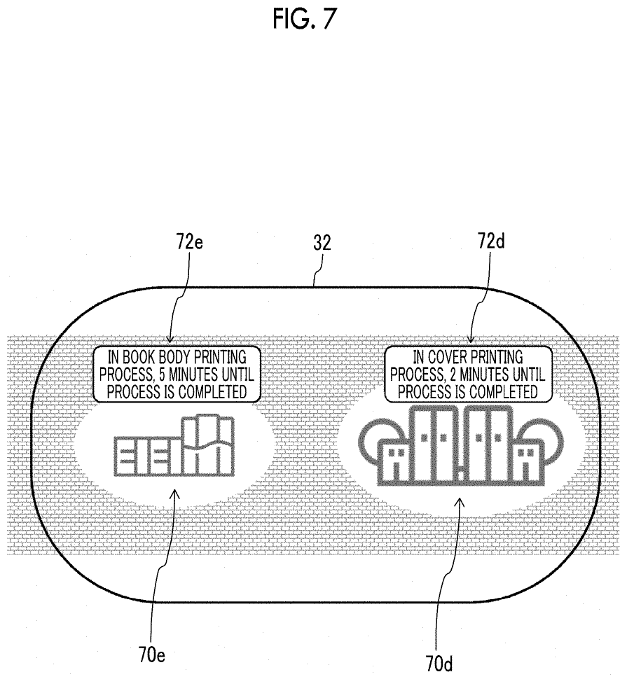

FIG. 7 is a diagram illustrating a second example of information displayed on the display 32. As described above, the display 32 displays information on only the device 12 related to the user U. Therefore, as illustrated in FIG. 7, the image 70d and the device status information 72d relating to the device 12d, and the image 70e and the device status information 72e relating to the device 12e are displayed on the display 32. Here, it should be noted that the information on the device 12f which is the device 12 present in the line-of-sight direction L of the user U and is not related to the user U is not displayed on the display 32.

Thus, information unnecessary for the user U is not displayed on the display 32, so that it is possible to suppress the display of the display 32 from becoming complicated.

In the above-described example of the workflow X for performing the case binding process, the device 12 related to the user U is the device 12 for performing the work included in the workflow X, but the device 12 related to the user U is not limited to this. For example, in a case where the user U is the administrator of a plurality of devices 12, the device 12 related to the user U may be the device 12 managed by the user U. In this case, in the user DB 54, the user ID of the user U is associated with the device ID of the device 12 managed by the user U. The display control unit 64 can identify the device 12 related to the user U (the device 12 managed by the user U) by referring to the user DB 54. That is, in this case, the information stored in the user DB 54 is the related information. Further, for example, in a case where the user U is the person in charge of repairing the device 12, the device 12 related to the user U may be the device 12 that is out of order. In this case, the display control unit 64 can identify the device 12 (the device 12 that is out of order) related to the user U by referring to the state of the device 12 stored in the device DB 56. That is, in this case, the information indicating the state of the device 12 stored in the device DB 56 is the related information.

In a case where in the workflow, the work performed by the user U is in the pre-process or the post-process of the work performed by using the device 12 at a position invisible to the user U, the display control unit 64 may display, on the display 32, information indicating the relationship between the progress of the work of the user U and the progress of the work performed by using the device 12 in the pre-process or the post-process.

For example, in the above-described example of the workflow X for performing the case binding process, the work (process C) performed by the user U using the device 12g is the post-process of the cover printing process (process A) performed by using the device 12d and the book body printing process (process B) performed by using the device 12e. In this case, the display control unit 64 first refers to the workflow DB 58 and acquires information on the workflow X (process order, user and device 12 performing the work of each process, and the like). Next, with reference to the device DB 56, the work progress of the devices 12d, 12e, and 12g is acquired from the device status information on the device 12g used for the work of the user U and the devices 12d and 12e used in the pre-process. Here, the device status information on the device 12g used for the work of the user U, which is stored in the device DB 56, corresponds to the user work information indicating the progress of the user's work. The display control unit 64 displays, on the display 32, information indicating the relationship of the progress of the work performed using the device 12, based on the acquired work progress of the device 12g (that is, the work progress of the user U) and the work progress of the devices 12d and 12e used in the pre-process.

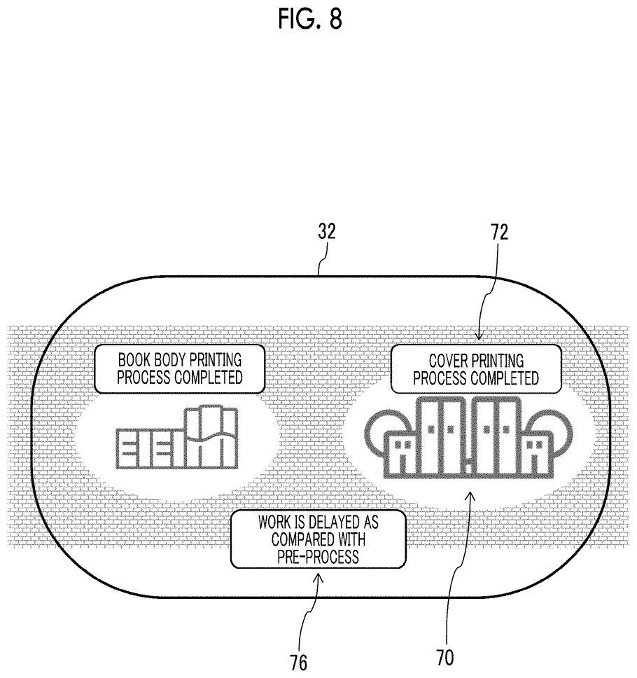

FIG. 8 is a diagram illustrating an example in which information indicating the relationship between the progress of the work performed by the user U and the progress of the work using the device 12 which is the pre-process is displayed on the display 32. For example, in a case where the work performed by the user U using the device 12g (that is, process C), which is the post-process, is delayed with respect to the work using the devices 12d and 12e which are the pre-processes (that is, the processes A and B), as illustrated in FIG. 8, the display control unit 64 displays, on the display 32, a notification message 76 indicating that the work of the user U is delayed as compared with the work in the pre-process. Thus, the user U can grasp that user's work is delayed as compared with the work in the pre-process.

On the contrary, in a case where the work performed by the user U using the device 12g (that is, process C), which is the post-process, is advanced from the work using the devices 12d and 12e which are the pre-processes (that is, the processes A and B), the display control unit 64 displays, on the display 32, a notification message indicating that the work of the user U is advanced as compared with the work in the pre-process. Thus, the user can grasp that user's work is advanced as compared with the work in the pre-process.

The same applies in a case where the work performed by the user U using the device 12g is a pre-process of the work performed using the device 12d. That is, in a case where the work performed by the user U using the device 12g which is the post-process is delayed (or advanced) with respect to the work using the devices 12d which is the pre-process, the display control unit 64 displays, on the display 32, a notification message 76 indicating that the work of the user U is delayed (or advanced).

In this example, information indicating the relationship between the progress of the work of the user U and the progress of the work performed by using the device 12 in the pre-process or the post-process is displayed on the display 32 in the form of the notification message 76. However, the information may be displayed on the display 32 by a method other than the notification message 76. For example, the display mode of the image 70 of the device 12 or the device status information 72 may be changed according to the relationship between the progress of the work of the user U and the progress of the work performed by using the device 12 in the pre-process or the post-process. For example, in a case where the work progress of the user U is advanced, the device status information 72 may be displayed in blue, and in a case where the work progress of the user U is delayed, the device status information 72 may be displayed in red. Of course, the method of displaying the information indicating the relationship between the progress of the work of the user U and the progress of the work performed by using the device 12 in the pre-process or the post-process is not limited to the above.

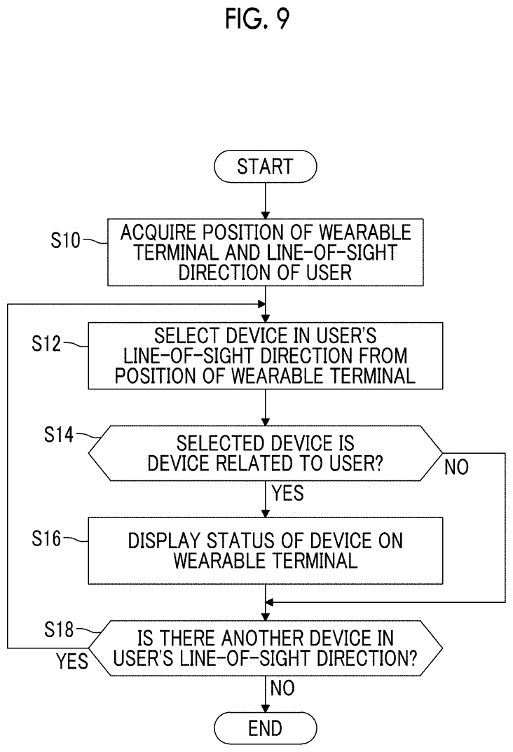

Hereinafter, the processing flow of the server 16 according to the first exemplary embodiment will be described with reference to the flowchart illustrated in FIG. 9.

In step S10, the server 16 receives the terminal ID, the received information received from the GPS satellite (or the position information indicating the position of the wearable terminal 14), and the line-of-sight direction information indicating the user's line-of-sight direction from the wearable terminal 14. The position direction acquisition unit 62 acquires the position of the wearable terminal 14, the user's line-of-sight direction, and the field of view, based on the information.

In step S12, the display control unit 64 refers to the installation location information of the device DB 56 and identifies the devices 12 in the user's line-of-sight direction acquired in step S10. The display control unit 64 selects one device 12 from among the identified devices 12.

In step S14, the display control unit 64 determines whether or not the device 12 selected in step S12 is the device 12 related to the user. For example, the display control unit 64 identifies the user ID of the user wearing the wearable terminal 14, based on the user DB 54 and the terminal ID received in step S10, and refers to the workflow DB 58 to identify the workflow including the work performed by the user. Then, it is determined whether or not the device 12 selected in step S12 performs the work included in the identified workflow. In a case where the device 12 selected in step S12 is the device 12 related to the user, the process proceeds to step S16, otherwise the process bypasses step S16 and proceeds to step S18.

In step S16, the display control unit 64 acquires the device status information regarding the device 12 selected in step S12, from the device DB 56, and displays the device status information on the display 32 of the wearable terminal 14.

In step S18, it is determined whether or not there is a device 12 that does not perform the processes in steps S14 and S16, among devices 12 present in the user's line-of-sight direction. Ina case where there is, the process returns to step S12, selects another device among the devices 12 present in the user's line-of-sight direction, and repeats the processes of steps S14 and S16. Ina case where there is not, the process ends.

### Second Exemplary Embodiment

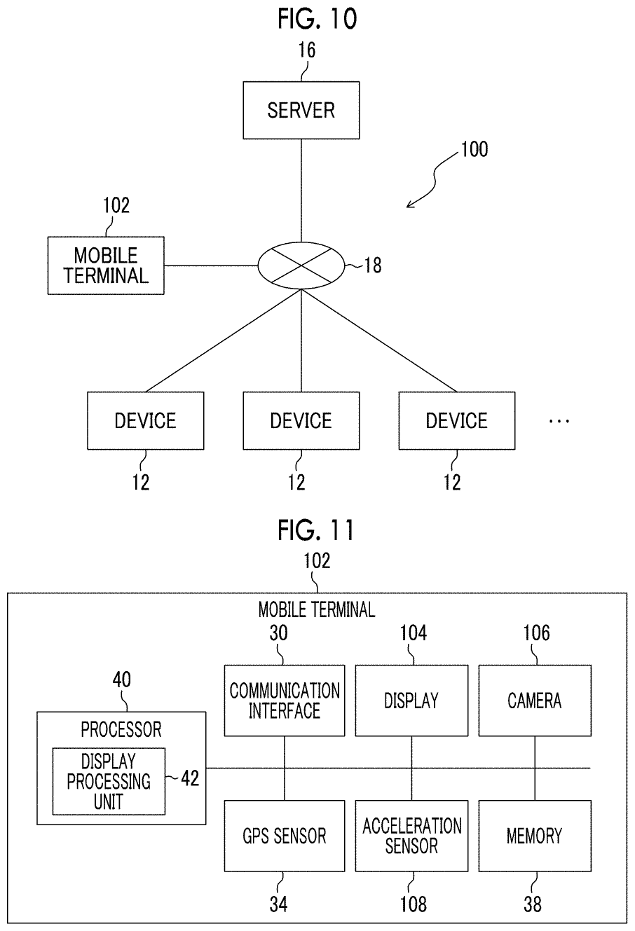

FIG. 10 is a schematic configuration diagram of an information processing system 100 according to a second exemplary embodiment. The information processing system 100 according to the second exemplary embodiment is different from the information processing system 10 according to the first exemplary embodiment in that the user uses a mobile terminal 102 instead of the wearable terminal 14. Hereinafter, the second exemplary embodiment will be described with reference to FIGS. 10 to 13, but the same configuration requirements as the configuration requirements of the first exemplary embodiment are designated by the same reference numerals as the configuration requirements of the first exemplary embodiment, and the description thereof will be omitted.

FIG. 11 is a schematic configuration diagram of the mobile terminal 102. The mobile terminal 102 is a terminal that can be carried by a user, and is, for example, a tablet terminal such as a smartphone. As illustrated in FIG. 11, the mobile terminal 102 includes the same configuration requirements as the wearable terminal 14 according to the first exemplary embodiment, but as configuration requirements different from the wearable terminal 14, includes a display 104, a camera 106, and an acceleration sensor 108.

The display 104 includes, for example, a liquid crystal display and an organic EL. The display 32 of the wearable terminal 14 of the first exemplary embodiment is a transmissive display, but the display 104 is an opaque display in which the other side of the display cannot be seen through. The display 104 may also be a transmissive display. The display 104 also functions as a so-called live view monitor that displays the image acquired by the camera 106 in real time.

The camera 106 includes lenses, an imaging element, and the like. The camera 106 is a digital camera, and can acquire captured images as image data.

The acceleration sensor 108 is a sensor that detects the acceleration of the mobile terminal 102 in three orthogonal axial directions. After calibrating, the posture of the mobile terminal 102 (particularly the camera 106) can be detected based on the detection signal of the acceleration sensor 108. Based on the posture detected by the acceleration sensor 108, the direction that the camera 106 faces (for example, the direction perpendicular to the lens surface of the camera 106 and away from the mobile terminal 102) can be acquired. The detection signal of the acceleration sensor 108 is transmitted from the communication interface 30 to the server 16.

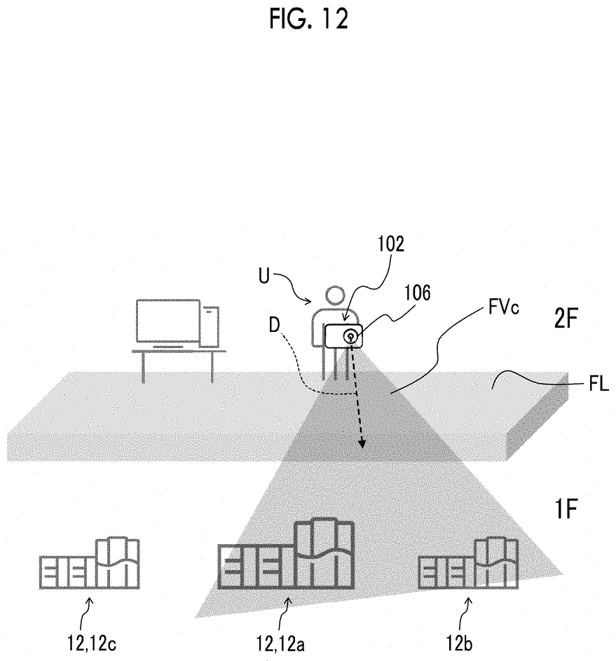

FIG. 12 is a diagram illustrating an example in which the user U points the camera 106 of the mobile terminal 102 toward the device 12. Similar to FIG. 4 of the first exemplary embodiment, in the example of FIG. 12, the user U is on the second floor of the building, and the plurality of devices 12 are installed on the first floor. The floor FL on the second floor is opaque, and the plurality of devices 12 are directly invisible to the camera 106 of the mobile terminal 102. Note that the device 12 directly invisible to the camera 106 refers to that the camera 106 cannot directly capture the device 12. Since the mobile terminal 102 is carried by the user U, in a case where the device 12 directly invisible to the camera 106, basically the user U also cannot directly see the device 12.

In this environment, it is assumed that the user U calibrates the acceleration sensor 108 and then points the camera 106 of the mobile terminal 102 toward the device 12 (that is, the direction of the floor FL). At this time, from the mobile terminal 102, the terminal ID of the mobile terminal 102, the received information received by the GPS sensor 34 (or the position information indicating the position of the mobile terminal 102), and the detection signal of the acceleration sensor 108 are transmitted to the server 16.

The position direction acquisition unit 62 of the server 16 acquires the position of the mobile terminal 102 indicated by the terminal ID and the direction D that the camera 106 faces, based on the information from the mobile terminal 102. Further, the position direction acquisition unit 62 acquires the field of view FVc (range that can be captured by the camera 106) of the camera 106. The field of view FVc of the camera 106 is a region within a predetermined angle of view centered on the direction D of the camera 106, with the position of the camera 106 as a reference (base point).

The display control unit 64 of the server 16 refers to the installation location information indicating the installation location of each device 12 stored in the device DB 56, and identifies a device 12 present in the direction D that the camera 106 faces (more specifically, within the field of view FVc of the camera 106), from the position of the mobile terminal 102. In the example of FIG. 12, devices 12a and 12b are identified.

Then, the display control unit 64 refers to the device DB 56, acquires information on the identified devices 12 (here, devices 12a and 12b), and transmits a display control signal for displaying the information on the display 104 of the mobile terminal 102, to the mobile terminal 102 indicated by the received terminal ID. Thus, the display control unit 64 causes the display 104 to display information on the identified device 12.

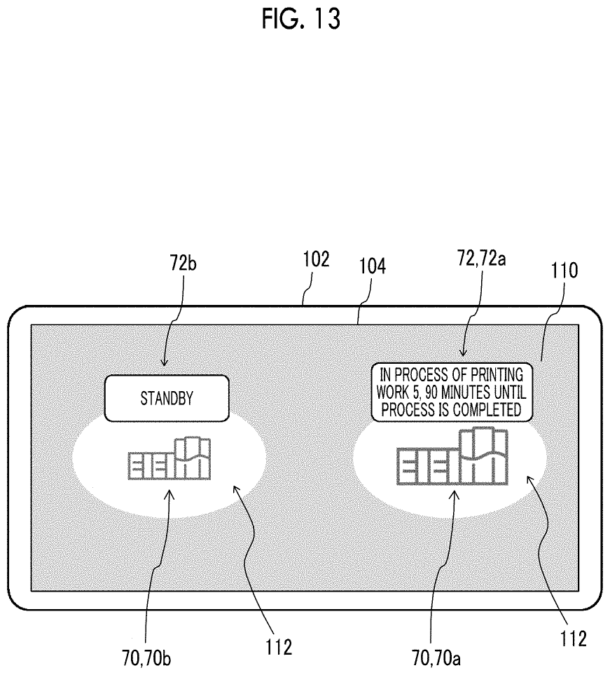

FIG. 13 is a diagram illustrating an example of information displayed on the display 104. The display processing unit 42 of the mobile terminal 102 causes the display 104 to display information on the device 12, based on the display control signal received from the server 16. Similar to the example of FIG. 5, in the example of FIG. 13, the image 70a of the device 12a, the device status information 72a of the device 12a, the image 70b of the device 12b, and the device status information 72b of the device 12b are displayed on the display 104.

As described above, the display 104 also functions as a live view monitor that displays the image acquired by the camera 106 in real time. Therefore, in the example of FIG. 13, the display control unit 64 displays the image captured by the camera 106 as the background image 110, and superimposes the information on the device 12 on the background image 110 to display the image.

In order to make the user feel as if the user is seeing the information on each device 12 through the floor FL displayed as the background image 110, the display control unit 64 may not display the background image 110 in the region around the image 70 of the device 12, and display the area as a white region 112.

Although the exemplary embodiments of the invention have been described above, the present invention is not limited to the above exemplary embodiments, and various modifications can be made without departing from the spirit of the present invention.

For example, in the present exemplary embodiment, the user DB 54, the device DB 56, and the workflow DB 58 are stored in the memory 52 of the server 16, but these databases may be stored in the memory of another apparatus accessible from the server 16.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire a position of an eye front-mounted wearable terminal having a transmissive display placed in front of eyes of a user and a user's line-of-sight direction; and
display, based on device information indicating an installation location and a status of a device at a position directly invisible to the user, the status of the device in the user's line-of-sight direction from the position of the wearable terminal, on the display.

2. An information processing apparatus comprising:
a processor configured to:
acquire a position of a mobile terminal having a camera and a display, and a direction that the camera faces; and
display, based on device information indicating an installation location and a status of a device at a position directly invisible to the camera, the status of the device in the direction that the camera faces, from the position of the mobile terminal, on the display.

3. The information processing apparatus according to claim 2,
wherein the status of the device is superimposed on an image acquired by the camera and displayed.

4. The information processing apparatus according to claim 1,
wherein the status of the device is an execution status of a work performed using the device.

5. The information processing apparatus according to claim 2,
wherein the status of the device is an execution status of a work performed using the device.

6. The information processing apparatus according to claim 3,
wherein the status of the device is an execution status of a work performed using the device.

7. The information processing apparatus according to claim 4,
wherein the execution status of the work is a progress of the work using the device.

8. The information processing apparatus according to claim 5,
wherein the execution status of the work is a progress of the work using the device.

9. The information processing apparatus according to claim 6,
wherein the execution status of the work is a progress of the work using the device.

10. The information processing apparatus according to claim 7,
wherein a work of the user is a work in a pre-process or a post-process of a work using the device, and
the processor is configured to:
refer to user work information indicating progress of the work of the user, and
display, on the display, information indicating a relationship between the progress of the work of the user and progress of the work using the device.

11. The information processing apparatus according to claim 8,
wherein a work of the user is a work in a pre-process or a post-process of a work using the device, and
the processor is configured to:
refer to user work information indicating progress of the work of the user, and
display, on the display, information indicating a relationship between the progress of the work of the user and progress of the work using the device.

12. The information processing apparatus according to claim 9,
wherein a work of the user is a work in a pre-process or a post-process of a work using the device, and
the processor is configured to:
refer to user work information indicating progress of the work of the user, and
display, on the display, information indicating a relationship between the progress of the work of the user and progress of the work using the device.

13. The information processing apparatus according to claim 10,
wherein the user works with a first product and a second product, and
a device related to the user is a device that produces the first product and a device that produces the second product.

14. The information processing apparatus according to claim 11,
wherein the user works with a first product and a second product, and
a device related to the user is a device that produces the first product and a device that produces the second product.

15. The information processing apparatus according to claim 12,
wherein the user works with a first product and a second product, and
a device related to the user is a device that produces the first product and a device that produces the second product.

16. The information processing apparatus according to claim 1,
wherein a plurality of the devices are provided, and
the processor is configured to:
display, on the display, a status of a device related to the user, among the plurality of devices, based on related information indicating a relationship between the user and the device related to the user.

17. The information processing apparatus according to claim 2,
wherein a plurality of the devices are provided, and
the processor is configured to:
display, on the display, a status of a device related to the user, among the plurality of devices, based on related information indicating a relationship between the user and the device related to the user.

18. The information processing apparatus according to claim 3,
wherein a plurality of the devices are provided, and
the processor is configured to:
display, on the display, a status of a device related to the user, among the plurality of devices, based on related information indicating a relationship between the user and the device related to the user.

19. A non-transitory computer readable medium storing an information processing program causing a computer to execute a process comprising:
acquire a position of an eye front-mounted wearable terminal having a transmissive display placed in front of eyes of a user and a user's line-of-sight direction; and
display, based on device information indicating an installation location and a status of a device at a position directly invisible to the user, the status of the device in the user's line-of-sight direction from the position of the wearable terminal, on the display.
